(19) United States
(12) Patent Application Publication
(10) Pub. No.: US 2024/0378527 A1
(43) Pub. Date: Nov. 14, 2024

(54) AMBIGUITY RESOLUTION FOR AUTOMATED PERFORMANCE OF TASKS

(71) Applicant: Wells Fargo Bank, N.A., San Francisco, CA (US)

(72) Inventors: Ishan Kalele, Bangalore (IN); Kiran Kumar Mushnuri, Telangana (IN); Sirisha Reddy Pundru, Telangana (IN); Arijit Ray, Karnataka (IN)

(21) Appl. No.: 17/205,652

(22) Filed: Mar. 18, 2021

(51) Int. Cl. G06Q 10/06; G06F 3/0482; G06F 40/174; G06Q 40/02

(52) U.S. Cl. CPC G06Q 10/0633; G06F 3/0482; G06F 40/174; G06Q 40/03

(57) ABSTRACT

Detecting ambiguities related to requested financial services tasks. The ambiguities can pertain to information regarding the requestor and/or information regarding the requested task. Questions and multiple-choice answers are generated to resolve the ambiguities. Selections from the multiple-choice answers are made, providing sufficient information to automatically perform the requested task.

### BACKGROUND

Customers and prospective customers of financial institutions commonly request performance of financial services tasks. Such tasks include, for example, obtaining pre-approval for a loan, modifying terms of an existing loan, opening or managing a checking account, savings account, or investment account, opening or managing a line of credit, etc. The initial request is typically made over the phone, in person (e.g., at a brick and mortar branch of a financial institution), or electronically, such as by email or using an interactive web-based platform provided by the financial institution.

In order for the financial institution to perform the requested task, a minimum amount of information needs to be obtained by the financial institution. Obtaining the minimum required information can be a cumbersome and inefficient process, requiring different types of measures to be employed depending on the customer or prospective customer, and the type of task that is requested.

### SUMMARY

Embodiments of the present disclosure are directed to automating efficient information gathering to perform financial services tasks.

Financial services tasks are performed by a financial institution, such as a bank or an investment firm. Financial services tasks performed by such institutions include, for example, opening or managing a checking account, savings account, or investment account, opening or managing a line of credit, managing payments or terms of a loan, etc. In accordance with embodiments of the present disclosure, questions and selectable (e.g., multiple choice) answers are formulated based on ambiguities in information accessible to the financial institution in order to solicit responses to the questions from a customer or prospective customer in a simple, high accuracy, and high efficiency manner.

By selecting from the automatically generated multiple choice answers to respond to the automatically generated questions, the ambiguities are resolved, allowing the financial institution to perform the requested financial services task. The financial institution thus performs the task without the need for a human representative of the financial institution to interact with the customer or prospective customer. In addition, the financial institution performs the task without the need for a human representative of the financial institution or a computerized model to interpret, distill or categorize responses from customers or prospective customers to open ended questions, which actions can lead to costly errors in understanding.

In one aspect, a computer implemented includes: receiving a request from a user to perform a financial services task; accessing internal information associated with the user; determining a minimum set of information required to perform the financial services task, the minimum set of information including a piece of information for which the internal information has an ambiguity; selecting, based on the internal information and a type of the financial services task, a question to resolve the ambiguity; generating, for the question and based upon the internal information, selectable answers corresponding to the question, with the selectable answers being possible correct answers that resolve the ambiguity, with one of the selectable answers being an actual correct answer that correctly resolves the ambiguity, and with another of the selectable answers being an incorrect answer that incorrectly resolves the ambiguity; and outputting the question and the selectable answers for display to the user.

In another aspect, the method includes determining a minimum number of questions required to solicit the minimum set of information.

In another aspect, the method includes generating the questions; generating, for each question and based upon the internal information, selectable answers corresponding to the question, with the selectable answers being possible correct answers that resolve the ambiguity, with one of the selectable answers being an actual correct answer that correctly resolves the ambiguity, and with another of the selectable answers being an incorrect answer that incorrectly resolves the ambiguity; and outputting the questions and the selectable answers for display to the user.

In another aspect, the method includes obtaining the minimum set of information by receiving, for each question, a selection of one of the selectable answers.

In another aspect, the method includes generating the questions; outputting the questions for display to the user; and outputting, for display to the user, a prompt for a corresponding one of the questions, the prompt including a user-fillable field for entering a monetary amount that answers the corresponding one of the questions.

In another aspect, the outputting the selectable answers includes outputting, via a graphical display, a selectable dropdown menu of the selectable answers or selectable radio buttons corresponding to the answers.

In another aspect, the generating selectable answers includes prioritizing the answers according to a priority order based on one or more prioritization rules.

In another aspect, the outputting the selectable answers includes displaying the selectable answers according to the priority order.

In another aspect, the type is one of: an opening of a new financial account; a refinancing of an existing loan; and an application for a new loan.

In another aspect, the internal information includes existing customer profile information and existing financial account information for the user.

In another aspect, a computer-implemented method, includes: receiving a request from a user to perform a financial services task; determining if the user is a first user or a second user; if the user is the first user: accessing first internal information associated with the first user; determining a first minimum set of information required to perform the financial services task, including determining that the first minimum set of information includes a first piece of information for which the first internal information has a first ambiguity; selecting, based on the first internal information and a type of the financial services task, a first question to resolve the first ambiguity; and outputting the first question for display to the user; and if the user is the second user: accessing second internal information associated with the second user; determining a second minimum set of information required to perform the financial services task, including determining that the second minimum set of information includes a second piece of information for which the second internal information has a second ambiguity, the second ambiguity being different from the first ambiguity; selecting, based on the second internal information and the type of the financial services task, a second question to resolve the second ambiguity; and outputting the second question for display to the user, wherein the first internal information does not have the second ambiguity; and wherein the second internal information does not have the first ambiguity.

In another aspect, the second question is different from the first question.

In another aspect, the first question and the second question are identical.

In another aspect, the method includes determining a first minimum number of questions required to solicit the first minimum set of information; and determining a second minimum number of questions required to solicit the second minimum set of information, the second number being different from the first number.

In another aspect, the first internal information indicates that the first user is an existing customer of a financial institution that can perform the financial services task; and the second internal information indicates that the second user is not an existing customer of the financial institution.

In another aspect, the type is one of: an opening of a new financial account; a refinancing of an existing loan; and an application for a new loan.

In another aspects, the method includes: generating, for the first question and based upon the first internal information, first selectable answers corresponding to the first question, with the first selectable answers being possible correct answers that resolve the first ambiguity, with one of the first selectable answers being an actual correct answer that correctly resolves the first ambiguity, and with another of the selectable answers being an incorrect answer that incorrectly resolves the first ambiguity; and generating, for the second question and based upon the second internal information, second selectable answers corresponding to the second question, with the second selectable answers being possible correct answers that resolve the second ambiguity, with one of the second selectable answers being an actual correct answer that correctly resolves the second ambiguity, and with another of the selectable answers being an incorrect answer that incorrectly resolves the second ambiguity, at least one of the second selectable answers being different from every one of the first selectable answers, wherein the first question and the second question are identical; and wherein each one of the first selectable answers is different from every one of the second selectable answers.

In another aspect, the first internal information includes existing customer profile information and existing financial account information for the first user; and the second internal information includes existing customer profile information and existing financial account information for the second user.

In another aspect, a system includes: one or more processors; and non-transitory computer-readable instructions that, when executed by the one or more processors, cause the system to: receive a request from a user via a graphical interface to perform a financial services task; access internal information associated with the user, including to obtain, using a screen scraper, data associated with the user from one or more websites; determine a minimum set of information required to perform the financial services task, the minimum set of information including a piece of information for which the internal information has an ambiguity; select, based on the internal information and a type of the financial services task, a question to resolve the ambiguity; generate, for the question and based upon the internal information, selectable answers corresponding to the question, with the selectable answers being possible correct answers that resolve the ambiguity, with one of the selectable answers being an actual correct answer that correctly resolves the ambiguity, and with another of the selectable answers being an incorrect answer that incorrectly resolves the ambiguity; output the question and the selectable answers for display to the user via a graphical display; obtain at least a portion of the minimum set of information, including to receive for the question a selection, via the graphical interface, of one of the selectable answers; and perform, subsequent to the obtain, the financial services task.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically shows components of an example system according to the present disclosure.

FIG. 2 is an example process flow and decision tree that can be performed using the system of FIG. 1.

FIG. 3 is a portion of an example interactive graphical interface generated by the system of FIG. 1.

FIG. 4 is a portion of a further example interactive graphical interface generated by the system of FIG. 1.

FIG. 5 schematically shows example computing components of a server of the system of FIG. 1.

### DETAILED DESCRIPTION

The present disclosure is directed to automated gathering of information to perform financial services tasks. It can be appreciated that principles of the present disclosure can be readily applied to institutions and business enterprises in industries other than the financial industry.

A financial institution stores and/or accesses information related to customers and prospective customers. As used herein, a “user” can refer to either a customer or potential customer of a financial institution or their agent. For example, a user can refer to a stakeholder of the financial institution who has the requisite knowledge (e.g., based on conversations with the customer or prospective customer) to respond to questions on the customer or potential customer's behalf and thereby resolve information ambiguities relating to the customer.

The financial institution also establishes and implements protocols for performing financial services transactions. The protocols can be based on statutory, regulatory, and/or other compliance constraints, such as internal policies and internal or external polices that dictate individualized treatment of different customers and prospective customers based on the type and/or extent of their relationship with the financial institution.

Typically, the information accessible to the financial institution will include ambiguous pieces of information and unambiguous, or known, pieces of information about the user.

An example of a known piece of information is the user's date of birth which, based on the internal information, is Jan. 1, 1980.

An example of an ambiguous piece of information is a user's residential address which, based on the internal information, is known to be one of two addresses. For example, the internal information can include two valid addresses for the user, with one being a business address and the other being a residential address, but the internal information does not indicate which of the addresses is the residential address. According to embodiments of the present disclosure, a question (e.g., “Which of these is your residential address?”) and two selectable answers (i.e., the two known addresses) are automatically generated and presented to the user, e.g., using a graphical interface. The user selects one of the two answers, thereby resolving the ambiguity with minimal effort by the user (selection of one of two multiple choice answers via a graphical interface), a minimum number of questions (one), and without human interaction with the user or a need to parse or interpret a user's response.

By resolving ambiguities present in information already accessible by the financial institution and building questions and multiple choice answers to those questions to resolve the ambiguities, several advantages and practical applications are realized. For example, embodiments of the present disclosure streamline interactions between institution and user, minimize potential points of interpretative error thereby increasing data accuracy when performing financial services tasks, save the institution's human resources, save the user's time, and improve the user's experience.

Further practical applications of embodiments of the present disclosure include the generation of graphical interfaces that present information ambiguities in a highly structured and optimized format that allows the ambiguities to be understood and resolved with minimal effort by the user.

Further practical applications of embodiments of the present disclosure include the generation of graphical interfaces through which ambiguities in information are resolved using specially formatted prompts and interactive selection tools.

Further practical applications of embodiments of the present disclosure include using specialized computer tools, such as screen scrapers, to harvest pieces of internal information for the institution from external websites. The harvested information can be unambiguous, or present ambiguities that systems and method of the present disclosure are configured to resolve. For example, using the information harvested from a screen scraper, a question with multiple choice answers is generated and presented to a user via a graphical interface. Then, one of the answers is selected via the graphical interface, resolving the ambiguity and allowing a financial services task to proceed. In some examples, the screen scraper introduces an ambiguity by locating the actual correct answer to a question, thereby avoiding making of an incorrect assumption based on the information available without the harvested information from the screen scraper.

By finding and resolving ambiguities, further practical applications of embodiments of the present disclosure include the automation of financial services tasks based on more accurate information than otherwise would have been available.

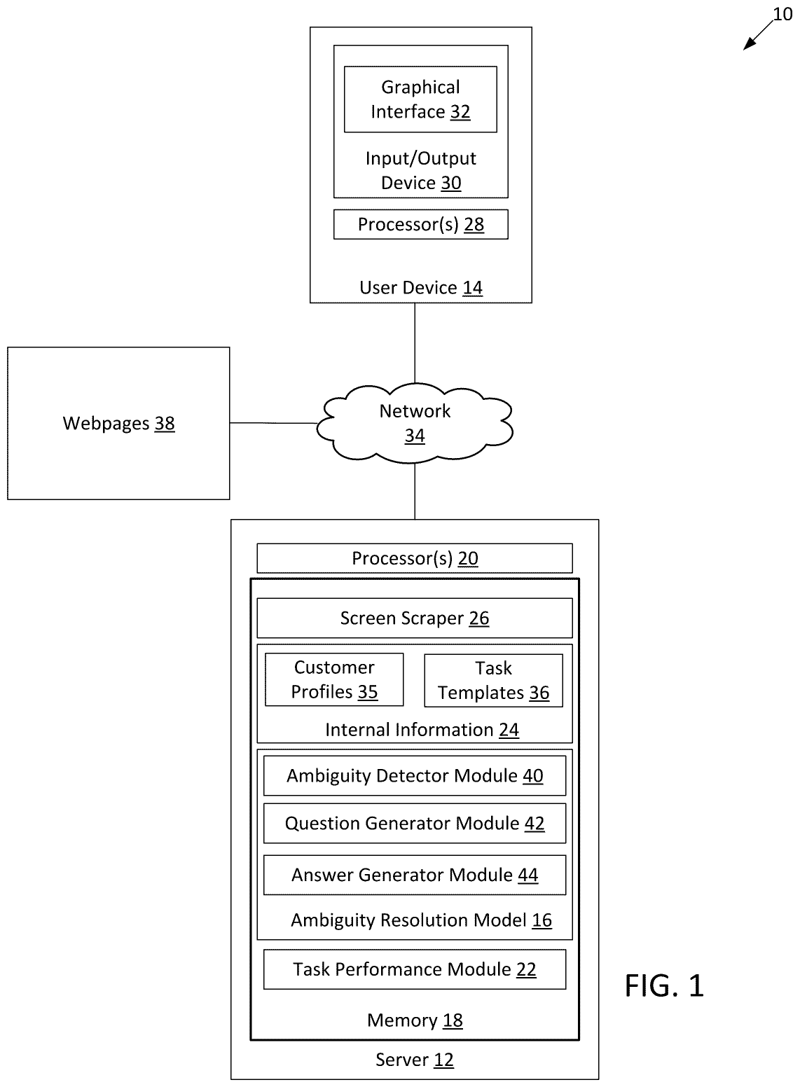

FIG. 1 schematically shows components of an example system 10 according to the present disclosure. The system 10 includes a server 12 and a user device 14.

The user device 14 is a computing device, such as a laptop computer, a desktop computer, a tablet computer, a smartphone, etc.

The server 12 is a computing device configured to perform ambiguity resolution using an ambiguity resolution model (ARM) 16 stored on a memory 18, as well as to perform financial services tasks for users who request the tasks using, e.g., the user device 14. The server 12 can be associated with a given financial services institution. The server 12 can be configured to be accessed only by the institution to which it is associated. Alternatively, the server 12 can correspond to shared computing resources, such as a cloud, to which a given institution can gain access for their private computing needs.

The server 12 includes one or more processor(s) 20 configured to process data and execute computer readable instructions stored on the memory 18 for performing functions of the server 12 described herein.

The memory 18 stores the ARM 16, a task performance module 22, internal information 24, and a screen scraper 26.

The user device 14 includes one or more processor(s) 28 and an input/output (I/O) device 30. The I/O device 30 includes a graphical interface 32, such as a touch screen. The processor(s) 28 can execute computer readable instructions for performing functions of the user device 14, such as displaying questions and multiple choice answers built around ambiguities in the internal information 24, and receiving answers to the questions to resolve those ambiguities that are input via the I/O device 30. The I/O device 30 can also be configured to receive an initial request from a user to perform a financial services task. The initial request can be entered via the graphical interface or another component of the I/O device 30, such as an audio device platform (e.g., a microphone).

The server 12 and the user device 14 are interconnected via a network 34. The network 34 can be any suitable data network, such as the internet, a wide area network, a local area network, a wired network, a wireless network, a cellular network, a satellite network, a near field communication network, or any operatively connected combination of these. Inputs to the user device 14 can be received by the server 12 via the network 34 and vice versa.

Internal information 24 includes customer profiles 35 and task templates 36. The internal information 24 can be stored on one or more databases. The internal information 24 stored on the one or more databases can be sourced from various internal information sources. Non-limiting examples of internal information sources include financial accounts of existing customers, interviews with existing or prospective customers, questionnaires that have been filled out by existing or prospective customers, and information previously provided by customers or prospective customers when making prior financial services requests of the financial institution.

Internal information can be collected from the one or more internal information sources to generate the customer profiles 35.

Customer profiles 35 includes information about customers of the financial institution such as name, address(es), date of birth, income, net worth, employer, account information, mortgage information, loan information, family information, etc.

Task templates 36 include rules and processes for performing specific financial services tasks once information required for the task is obtained. For example, task templates 36 can include rules templates that use the customer profiles 35 and other internal information 24 to run processes for opening a checking or savings account, applying for a mortgage or other loan, restructuring (e.g., refinancing or recasting) a mortgage or other loan (e.g., a home equity loan), opening a credit card account, selling or buying an investment, etc.

The task performance module 22 is configured to use one or more templates from the task templates 36, data from the customer profiles 35, and/or other internal information 24 to perform or execute a financial services task that has been requested by a user.

The screen scraper 26 is configured to obtain data from external sources, such as webpages 38. For example, the screen scraper 26 can be configured to harvest data from publicly available webpages and webpages that the financial institution is authorized to access such as social media profiles and posts associated with a user, market data associated with a neighborhood in which a user owns or seeks to purchase a home, data associated with a user's employer, etc.

In addition to the webpages 38, external sources of external information can include various databases external to the financial institution that store publicly accessible information about customers and/or prospective customers, and/or for which access has been permitted to the financial institution by the customer or prospective customer. Such databases can include for, example, databases of other financial institutions, databases of medical, travel, social media, and other service providers, government databases that store, for example, tax documents, lien documents, judgment or other judicial proceeding documents, real estate documents, and so forth.

Data harvested by the screen scraper 26 or through another means from one or more sources of external information can be committed to the internal information 24. In some examples, data harvested by the screen scraper 26 can supplement customer profiles 35.

The supplemental data can generate an ambiguity with respect to already stored data in the internal information. For example, the screen scraper 26 obtains data from a social media webpage that a customer has a new job, which renders ambiguous a previously stored piece of information in the internal information 24 that the customer has been an employee of a particular company for the past five years.

Alternatively, the supplemental data can be unambiguous. For example, the supplemental data obtained by the screen scraper 26 can include a piece of information that a particular customer owns a particular make and model of a vehicle, whereas no prior stored information in the internal information 24 indicated whether the customer owns a vehicle.

The ARM 16 includes an ambiguity detector module 40, a question generator module 42, and an answer generator module 44.

The ambiguity detector module 40 is configured to analyze the internal information 24 and determine whether any ambiguities exist with respect to that information that need to be resolved in order to perform a user-requested financial services task.

Ambiguities detected by the ambiguity detector module are passed to the question generator module 42 and the answer generator module 44.

The question generator module 42 is configured to formulate multiple choice questions built around the ambiguous information. In some examples, the question generator module 42 is configured to minimize the number of multiple choice questions to resolve the ambiguities that need to be resolved in order to perform a requested financial services task.

The answer generator module 44 is configured to formulate a plurality of selectable answers to each question formulated by the question generator module 42, based on the ambiguous internal information 24.

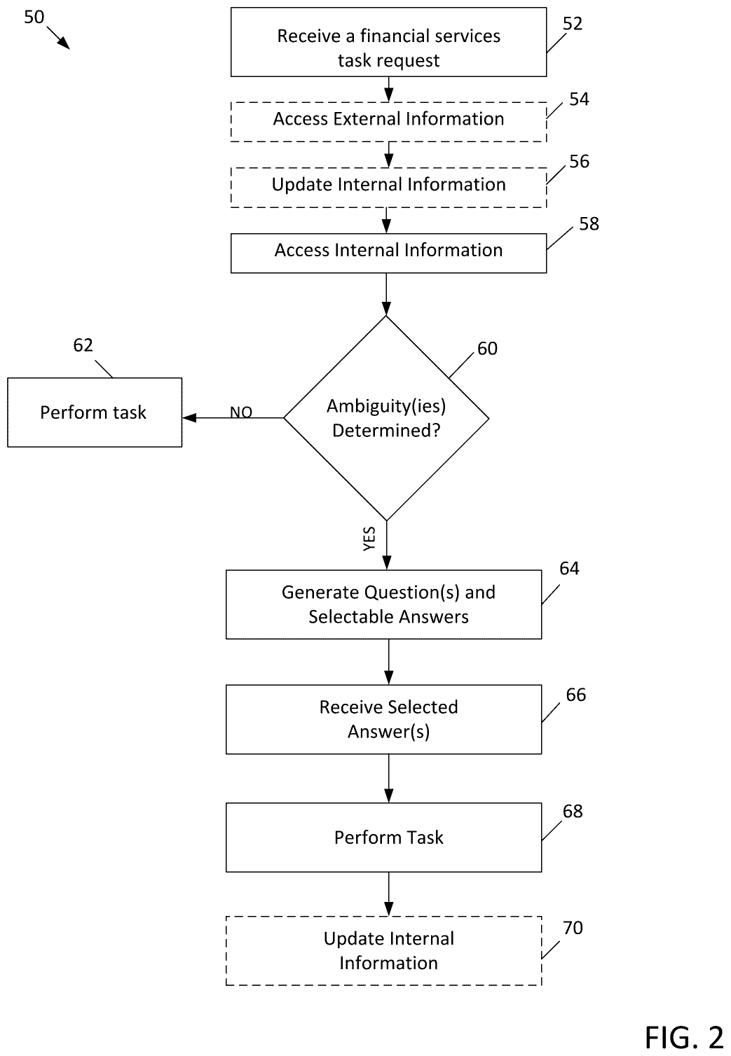

In some examples, the answer generator module 44 is configured to prioritize the selectable answers according to one or more prioritization rules and to cause the selectable answers to be displayed in a manner that shows or emphasizes the hierarchy of a priority. Prioritization by the answer generator module 44 will be discussed in greater detail below in connection with FIG. 2.

In some examples, the question generator module 42 is configured to generate a minimum number of questions required to solicit a minimum set of information required to perform the requested financial services task.

In some examples, the question generator module 42 and answer generator 44 are configured to generate a minimum number of questions all with corresponding sets of selectable answers, the number of questions being the minimum number of questions required to solicit a minimum set of information required to perform the requested financial services task.

The question generator module 42 is configured to determine the minimum set of information needed to perform a requested financial services task, and thereby generate questions to solicit that minimum set of information, based on the type of financial services task that has been requested, and based on what is known, not known, and/or ambiguous with respect to the internal information 24.

Non-limiting examples of types or categories of types of financial services tasks that can be requested include an opening of a new financial account type or category, a restructuring (e.g., a refinancing, a recasting) of an existing loan type or category, a request of for loan relief (e.g., forbearance) type or category, an application for a new loan type or category, etc.

Each type or category of types of task requires corresponding types of information relevant to that task. For example, a loan forbearance task may require information relating to financial hardship, new employment attempts, an unforeseen disaster, etc., whereas an opening a checking account task may require details relating to income and existing bank accounts. The types of information needed for a given task can be accessed by the ambiguity detector module 40, the question generator module 42 and/or the answer generated module 44 in the corresponding task template 36.

The ambiguity detector module 40 is configured to determine an ambiguity in the internal information 24 that is pertinent to a particular task that has been requested based on the information needed to perform the requested task and the type of task. The question generator module 42 and the answer generator module 44 then provide questions and selectable answers to resolve the pertinent ambiguity or ambiguities so that the task can be performed or submitted for approval to be performed once the questions are answered.

Because the information required to perform a task is task type specific, the number of questions generated and the information to be solicited by those questions, may differ from one task to another. Likewise, the selectable answers may differ for the same question posed with respect to two different tasks.

Because the internal information 24 that is available may be different from user to user, for a given financial services task that is requested, the pertinent ambiguities may differ, such that the generated questions differ in number and/or information solicited. Likewise, the selectable answers may differ for the same question posed with respect to the same task requested by two different users. For example, two different users request a loan forbearance. A pertinent ambiguity as to whether the users' homes were impacted by a natural disaster is determined for each request. However, based on the known geographic locations of the two homes, the question generator module 42 and answer generator module 44 generate questions and selectable answers such that one of the users is asked whether their home was impacted by a specific hurricane known to have caused damage in the vicinity of that user's home, while the other user is asked whether their home was impacted by a specific earthquake known to have caused damaged in the vicinity of that user's home.

Once the question(s) and selectable answers to each question have been generated, the ARM 16 outputs the question(s) and selectable answers, which are received, via the network 34 at the user device 14. The user is presented at the graphical interface 32 with the question(s) and selectable answers. The user selects one of the answers to each question using the graphical interface 32, and the selection is provided to the server 12. The server 12 then updates the internal information 24 with the resolved ambiguity. The updated internal information 24 is then used to by the task performance module 22 to perform, also using the appropriate task template(s) 36, the particular financial services task requested by the user. For example, the task performance module 22 automatically opens an account, updates terms of a loan, or services a loan. Alternatively, the task performance module 22 submits a completed proposed account opening task, a completed proposed loan updating task, or completed proposed loan servicing task, for approval by a stakeholder of the financial institution and, once approval has been provided, the task is executed by the server 12.

FIG. 2 is an example process flow and decision tree 50 that can be performed using the system of FIG. 1.

At a step 52 of the process flow 50, a request for performance of a financial services task is requested by a user. For example, the task request is submitted using the user device 14 and received by the server 12 (FIG. 1). In one particular example of the process flow 50, the task request is made by an existing customer for loan relief associated with a mortgage on a property of the customer located in Minnesota.

At an optional step 54, external information is accessed and harvested. The external information can be obtained from one or more external information sources, such as the external information sources described herein. The external information can be obtained using any suitable means. In some examples, the external sources contain publicly accessible information. In some examples, the user authorizes the financial institution to access external information about the customer or prospective customer from an external source.

In some examples, the external source (e.g., a database) can be queried by the financial institution to obtain external information about the user.

In some examples, the screen scraper 26 (FIG. 1) harvests information about the user who made the financial services task request from the one or more webpages 38 (FIG. 1) In some examples, the screen scraper 26 harvests information about the user from webpages associated with one or more of the external information sources.

For instance, in the one particular example of the process flow 50, at the step 54, the financial institution obtains publicly accessible external information from a webpage associated with a governmental database that the customer pays real property taxes on the property in Minnesota and a property in Michigan, indicating that the customer's primary residence may be at the address associated with the Minnesota property or may be at an address associated with the Michigan property.

At an optional step 56, information harvested at the step 54 is used to update the internal information 24 (FIG. 1) associated with the user who made the financial services request. The internal information 24 can be updated or supplemented to introduce an ambiguity. Alternatively, the internal information can be updated or supplemented with unambiguous information. For instance, in the one particular example of the process flow 50, the internal information 24 is updated to introduce an ambiguity as to the primary residence of the user as between the Minnesota property and the Michigan property.

At a step 58, the internal information 24 (FIG. 1) is accessed based on the submitted task request. The internal information 24 is obtained from one or more of the internal information sources described herein. In some examples, at the step 58, the internal information 24 that is accessed is updated based on the external information obtained at step 54.

If the user is an existing customer of the financial institution, the internal information can include known information about the customer, such as information pertaining to existing accounts, existing loans, existing personal information, etc. For instance, in the one particular example of the process flow 50, the user is an existing customer, and the internal information accessed at the step 58 pertains to internally stored and accessible information about the mortgage for the Minnesota property, including, e.g., the mortgage interest rate, an amortization schedule for the mortgage, payment history for the mortgage, refinance history for the mortgage, payment default history for the mortgage and/or or other loans issued to the customer, loan relief history for the mortgage and/or other loans issues to the customer, value of the property, and so forth.

If the user is not an existing customer of the financial institution, the internal information can indicate that the user is not an existing customer. In addition, the internal information can include information from a potential customer intake session between the financial institution and the potential customer, from publicly available information (e.g., using the screen scraper 26 of FIG. 1), and/or from any external information source, such as those described herein, which external information has been harvested and committed to the internal information 24 (FIG. 1).

At a step 60, the ambiguity detector module 40 (FIG. 1) analyzes the internal information relevant to the task request and determines whether the information needed to perform the task includes an ambiguity. In some examples, the ambiguity detector module uses the templates 36 to determine the information that is relevant and needed to process the user's requested financial services task. For instance in the one particular example of the process flow 50, at the step 60 the ambiguity detector module 40 (FIG. 1) accesses a template 36 pertaining to mortgage relief requests and, based on the accessed template, determines that, to process the customer's request, it must be known whether the mortgage in question relates to the customer's primary residence, and it must be known whether the customer is delinquent on any real property taxes.

If the ambiguity detector module 40 (FIG. 1) determines that there is no ambiguity, then at the step 62, the task performance module 22 (FIG. 1) performs the requested task (or submits the task for approval) using one or more templates 36 (FIG. 1). Alternatively, additional needed information not pertaining to an ambiguity in the internal information 24 is solicited from the user and, once that information is obtained, the task performance module 22 performs the requested task using one or more templates 36 (FIG. 1).

If the ambiguity detector module 40 (FIG. 1) determines that there is one or more ambiguities, then at a step 64 the question generator module 42 (FIG. 1) generates a minimum number of questions based on the detected ambiguity(ies) and the answer generator module 44 (FIG. 1) generates possibly correct selectable answers for the generated question based on the ambiguous internal information.

For instance, in the one particular example of the process flow 50, the ambiguity detector module 40 (FIG. 1) determines, by analyzing the internal information that has been updated with the harvested external information, that there is an ambiguity as to the property that is the customer's primary residence. In addition, the ambiguity detector module 40 (FIG. 1) determines, by analyzing the internal information that has been updated with the harvested external information, that there is no ambiguity that the customer is not delinquent in paying property taxes on either of the two properties. Accordingly, and using the template(s) 36 pertaining to the customer's requested financial services task for loan relief for a real property mortgage, the question generator module 42 (FIG. 1) generates a question, e.g., “Which of the following is your primary residence?”, and the answer generator module 44 (FIG. 1) generates two possibly correct selectable answers for the generated question based on the ambiguous internal information, the first selectable answer being the Minnesota property, and the second selectable answer being the Michigan property. In addition, because the ambiguity detector module determined no ambiguity with respect to property tax delinquency on the two properties, no question or selectable relating to property tax delinquency on the two properties is generated by the question generator module 42 (FIG. 1) and the answer generator module 44 (FIG. 1), respectively.

The question(s) and answers are presented to the user via the graphical interface 32.

In some examples, at a step 65, the answer generator module 44 is configured to prioritize the selectable answers according to one or more prioritization rules and to cause the selectable answers to be displayed in a manner that shows or emphasizes the hierarchy of a priority. For example, an ambiguity can relate to whether a user desires to pursue a first course of action or a second course of action in connection with a requested financial services task, both of which actions are permitted and valid. In this example, the internal information 24 (FIG. 1) does not indicate one way or the other as to which course of action might be desired by the user. The answer generator module 44 uses prioritization rules to prioritize the first course of action over the second course of action, resulting in an ambiguity in the internal information 24. For example, the first course of action may carry fewer fees (e.g., banking or transactional fees) than the second course of action, or otherwise be more financially beneficial to the user. According to this example, the answer generator module 44 is configured to cause the selectable answers to be displayed in a manner that shows or emphasizes that the first course of action is prioritized over the second course of action. This can be achieved, for example, by displaying the first course of action above the second course of action on the graphical interface 32 (FIG. 1), using bold, colored, enlarged or other distinguishing font, etc., and/or by generating a default selected answer corresponding to the highest priority answer that the user must de-select in order to select a different answer.

At a step 66 an answer to each question generated at step 66 is selected at the graphical interface 32 (FIG. 1) and received by the server 12, the selected answer being the actually correct answer that resolves the ambiguity for which the corresponding question and selectable answers were generated at the step 64. For instance, in the one particular example of the process flow 50, at the step 66, the customer selects the answer that their primary residence is the Minnesota property.

At a step 68, once all ambiguities have been resolved, the task performance module 22 (FIG. 1) performs the requested task using one or more templates 36 (FIG. 1). Alternatively, additional needed information not pertaining to an ambiguity in the internal information 24 is solicited from the user and, once that information is obtained, the task performance module 22 performs the requested task using one or more templates 36 (FIG. 1).

At an optional step 70, the internal information 24 (FIG. 1) is updated based on the user's response(s) to the multiple choice question(s) received at the step 66, such that the internal information 24 is updated to reflect resolution of one or more previously present ambiguities. For instance, in the one particular example of the process flow 50, the internal information 24 is updated to reflect that the customer's primary residence is the Minnesota property. The updated internal information 24 can be used to perform one or more financial services tasks requested by the user in the future.

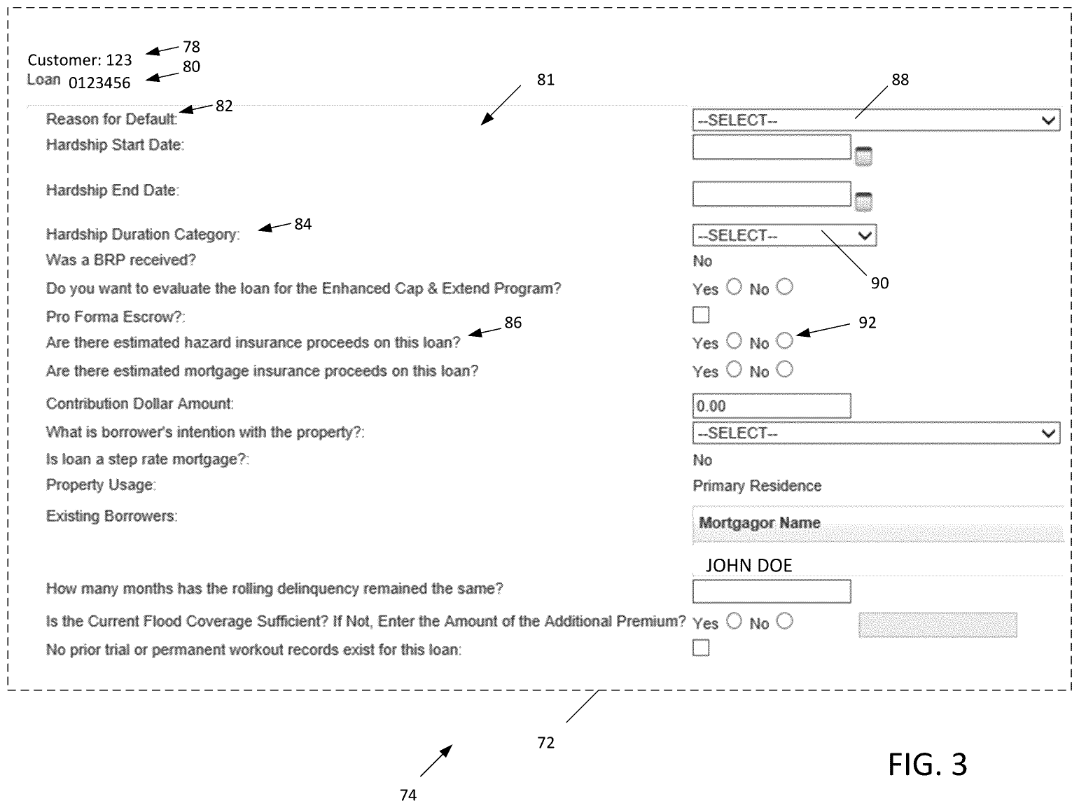

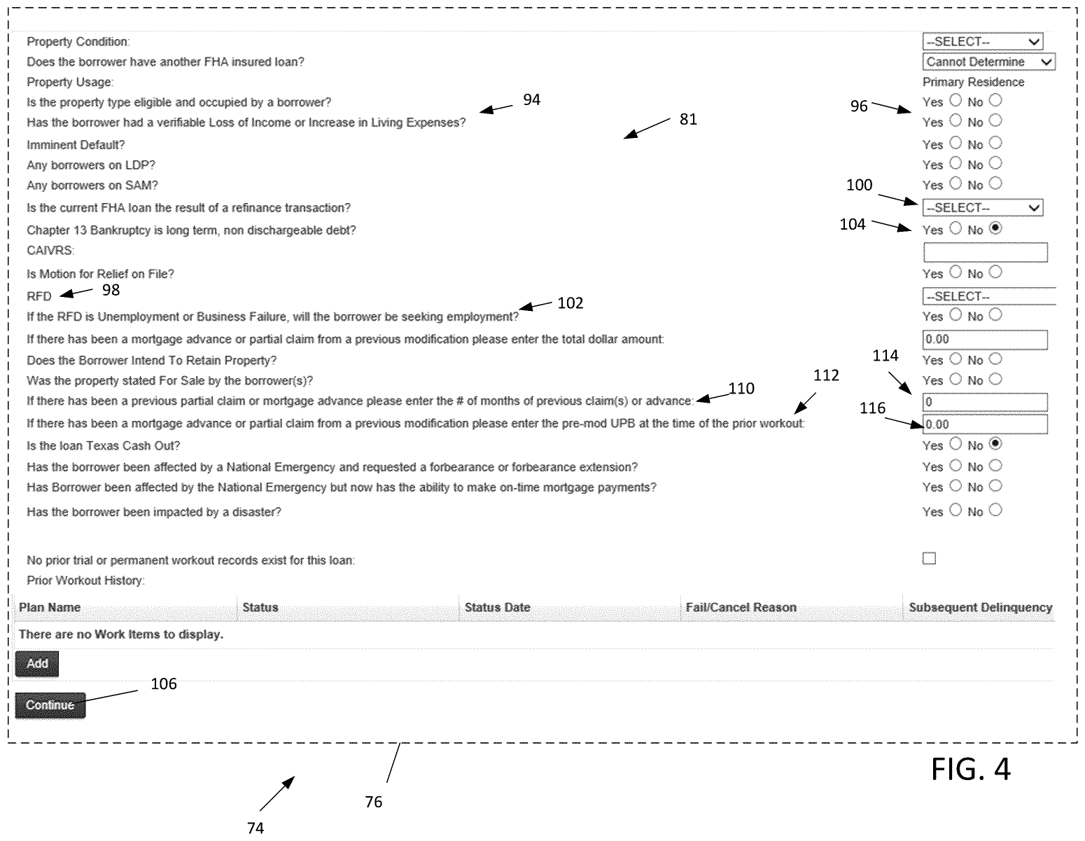

FIG. 3 shows a portion 72 of an example interactive graphical display 74 generated by the system 10 of FIG. 1. FIG. 4 shows a further portion 76 of the interactive graphical display 74. The interactive graphical display 74 can be displayed using the graphical interface 32 (FIG. 1).

Referring to FIGS. 3 and 4, in this example, a user is an existing customer of a financial institution and is initiating a request with the financial institution. The customer is a mortgagor of a mortgage for a home and the financial institution is the mortgagee of the mortgage. The mortgagor has defaulted on their mortgage payments and is requesting relief from the financial institution.

To determine whether relief can be provided and, if so the type of relief that can be provided to the user, the server 12 (FIG. 1) generates a series of questions for the user to answer via the interactive graphical display 74. The questions are based on the internal information 24 (FIG. 1), which includes known and ambiguous information about the user, as well information regarding data essential to performing the relief requested by the user. Several of these questions are generated by the ARM 16 (FIG. 1) based on ambiguities in the internal information 24 detected by the ambiguity detector module 40. The questions based on ambiguities are provided with a finite number of selectable possibly correct answers generated by the answer generator module 44 (FIG. 1), some of which sets of selectable possibility correct answers are prioritized based on one or more prioritization rules. The questions and selectable answers are presented using the graphical interface 32 (FIG. 1).

The interactive graphical display 74 can be displayed after the user has, e.g., logged into an account with the financial institution and submitted a request for loan relief associated with a particular loan (in this case, a mortgage), e.g., by identifying the loan and navigating to a loan management dashboard.

The interactive graphical display 74 includes a customer identifier 78 and a loan identifier 80. The customer identifier 78 identifies the user making the request and the loan identifier 80 identifies the loan about which a request for relief has been made.

The interactive graphical display 74 includes questions 81. In some examples, the questions 81 represent the minimum number of questions needed to obtain the needed information to render a decision (e.g., perform or not perform) regarding the requested financial services task and, optionally, to perform the task.

The questions 81 includes questions configured to resolve ambiguities in the internal information 24 (FIG. 1) relating to the user. For example, the question 82 solicits a reason for the user's loan default. Selectable answers to the question 82 can be displayed by selection of the dropdown menu 88 corresponding the question 82. In some examples, the selectable answers are displayed in a prioritized order according to one or more prioritization rules.

As another example, the question 84 solicits a categorization for the user's hardship that caused the user's default. Selectable answers to the question 84 can be displayed by selection of the dropdown menu 88 corresponding the question 84. In some examples, the selectable answers are displayed in a prioritized order according to one or more prioritization rules.

In some examples, the user can select multiple correct answers to a single question.

As another example, the question 86 solicits confirmation on whether there are estimated hazard insurance proceeds on the loan. Selectable answers to the question 86 are displayed using radio buttons 92.

Further questions 81 and their corresponding answers as presented using the interactive graphical display 74 are generated to resolve detected ambiguities related to how the mortgaged property is used by the user, the user's income, whether the user has been impacted by a national emergency or disaster, whether the current loan is a refinance loan, etc. Questions are formulated to be answered by selection of a selectable answer among multiple possibly correct answers. For example, with respect to income, the question 94 asks if the user has had a verifiable loss of income or an increase in living expenses, and the selectable radio button answers 96 are either “Yes” or “No”.

As another example, the question 98 solicits a reason for the loan default. The user can select a reason for the default from the corresponding dropdown menu 100. The question 102 asks, if the reason entered via the drop menu 100 is unemployment or business failure, whether the borrower will be seeking employment. Selectable “Yes” or “No” radio buttons 104 corresponding to the question 102 are selectable by the use to answer the question 102.

The user enters answers to the questions 81 and clicks the button 106 to submit the request for relief. If the user has provided the minimum information solicited by the questions 81 for the financial institution to render a decision on the user's request, then the decision is rendered. If the rendered decision is to perform a task, then the task performance module 22 causes the task to be performed, e.g., issuing a loan forbearance that can be communicated to the user.

In some examples, not all of the generated questions have selectable answers. For example, the questions 110 and 112 have, corresponding thereto on the interactive graphical display 74, a prompt 114, 116, each prompt 114, 116 including a user-fillable field for entering a quantity (e.g., a number of months, a monetary amount) that answers the corresponding one of the questions 110, 112.

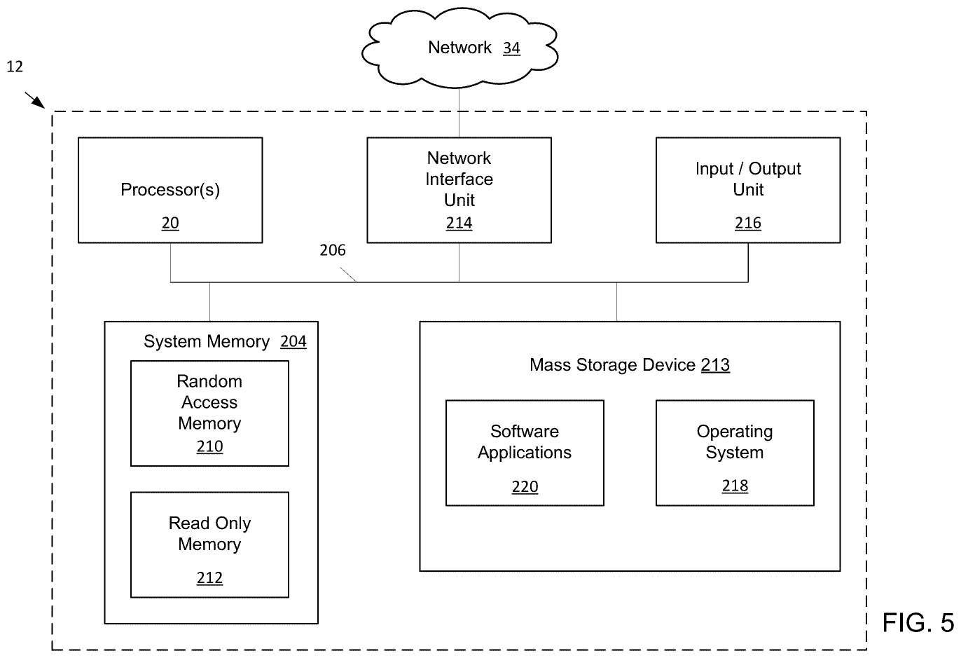

Additional components of the server 12 are illustrated in FIG. 5. In this example, the server 12 provides the computing resources to perform the functionality associated with the system 10 (FIG. 1). The user device 14 and other computing resources associated with the system 10 can be similarly configured.

The server 12 can be an internally controlled and managed device (or multiple devices) of the financial institution. Alternatively, the server 12 can represent one or more devices operating in a shared computing system external to the institution or institution, such as a cloud. Further, the other computing devices disclosed herein can include the same or similar components, including the user device 14.

Via the network 34, the components of the server 12 that are physically remote from one another can interact with one another.

The server 12 includes the processor(s) 20, a system memory 204, and a system bus 206 that couples the system memory 204 to the processor(s) 20.

The system memory 18 includes a random access memory (“RAM”) 210 and a read-only memory (“ROM”) 212. A basic input/output system that contains the basic routines that help to transfer information between elements within the server 12, such as during startup, is stored in the ROM 210.

The server 12 further includes a mass storage device 213. The mass storage device 213 can correspond to the memory 18 of the system 10 (FIG. 1). The mass storage device 213 is able to store software instructions and data, such as the task performance module 22, the ARM 16, the screen scraper 26, and the internal information 24 (FIG. 1).

The mass storage device 213 is connected to the processor(s) 20 through a mass storage controller (not shown) connected to the system bus 206. The mass storage device 213 and its associated computer-readable data storage media provide non-volatile, non-transitory storage for the server 12. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server 12.

According to various embodiments of the invention, the server 12 may operate in a networked environment using logical connections to remote network devices through the network 34, such as a wireless network, the Internet, or another type of network. The server 12 may connect to the network 34 through a network interface unit 214 connected to the system bus 206. It should be appreciated that the network interface unit 214 may also be utilized to connect to other types of networks and remote computing systems. The server 12 also includes an input/output unit 216 for receiving and processing input from a number of other devices, including a touch user interface display screen, an audio input device, or another type of input device. Similarly, the input/output unit 216 may provide output to a touch user interface display screen or other type of output device, including, for example, the I/O device 30 (FIG. 1).

As mentioned briefly above, the mass storage device 213 and/or the RAM 210 of the server 12 can store software instructions and data. The software instructions include an operating system 218 suitable for controlling the operation of the server 12. The mass storage device 213 and/or the RAM 210 also store software instructions and applications 220, that when executed by the processor(s) 20, cause the server 12 to provide the functionality described above.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer-implemented method, comprising:
receiving a request from a user to perform a financial services task;
accessing, from a source, internal information associated with the user;
accessing, from another source different from the source, additional information associated with the user;
updating the internal information based on the additional information, the updating introducing an ambiguity to the internal information that contradicts the internal information, to provide updated internal information;
determining a minimum set of information required to perform the financial services task, the minimum set of information including a piece of information corresponding to the ambiguity;
selecting, based on the updated internal information and a type of the financial services task, a question to resolve the ambiguity;
generating, for the question and based upon the updated internal information, selectable answers corresponding to the question, with the selectable answers being possible correct answers that resolve the ambiguity, with one of the selectable answers being an actual correct answer that correctly resolves the ambiguity, and with another of the selectable answers being an incorrect answer that incorrectly resolves the ambiguity;
outputting the question and the selectable answers for display to the user;
resolving the ambiguity to provide a resolved ambiguity, including:
in response to receiving an input of a first of the selectable answers, updating the internal information to reflect that the first of the selectable answers is correct; and
in response to receiving an input of a second of the selectable answers, updating the internal information to reflect that the second of the selectable answers is correct; and after resolving the ambiguity;
receiving another request from the user to perform another financial services task; and
performing the another financial services task using the resolved ambiguity.

2. The method of claim 1, further comprising determining a minimum number of questions required to solicit the minimum set of information.

3. The method of claim 2, further comprising:
generating the questions;
generating, for each question and based upon the internal information, selectable answers corresponding to the question, with the selectable answers being possible correct answers that resolve the ambiguity, with one of the selectable answers being an actual correct answer that correctly resolves the ambiguity, and with another of the selectable answers being an incorrect answer that incorrectly resolves the ambiguity; and
outputting the questions and the selectable answers for display to the user.

4. The method of claim 3, further comprising:
obtaining the minimum set of information by receiving, for each question, a selection of one of the selectable answers.

5. The method of claim 2, further comprising:
generating the questions; and
outputting the questions for display to the user.

6. The method of claim 5, further comprising:
outputting, for display to the user, a prompt for a corresponding one of the questions, the prompt including a user-fillable field for entering a monetary amount that answers the corresponding one of the questions.

7. The method of claim 1, wherein the outputting the selectable answers includes outputting, via a graphical display, a selectable dropdown menu of the selectable answers or selectable radio buttons corresponding to the answers.

8. The method of claim 1,
wherein the generating selectable answers includes prioritizing the answers according to a priority order based on one or more prioritization rules.

9. The method of claim 8,
wherein the outputting the selectable answers includes displaying the selectable answers according to the priority order.

10. The method of claim 1, wherein the type is one of:
an opening of a new financial account;
a refinancing of an existing loan; and
an application for a new loan.

11. The method of claim 1, wherein the internal information includes existing customer profile information and existing financial account information for the user.

12. A computer-implemented method, comprising:
receiving a request from a user to perform a financial services task;
determining if the user is a first user or a second user;
if the user is the first user:
accessing, from a source, first internal information associated with the first user;
accessing, from another source different from the source, additional information associated with the first user;
updating the internal information based on the additional information, the updating introducing a first ambiguity to the internal information that contradicts the internal information, to provide updated first internal information;
determining a first minimum set of information required to perform the financial services task, including determining that the first minimum set of information includes a first piece of information corresponding to the first ambiguity;
selecting, based on the updated first internal information and a type of the financial services task, a first question to resolve the first ambiguity;
generating, for the first question and based upon the updated first internal information, first selectable answers corresponding to the first question, with the first selectable answers being possible correct answers that resolve the first ambiguity, with one of the first selectable answers being an actual correct answer that correctly resolves the first ambiguity, and with another of the first selectable answers being an incorrect answer that incorrectly resolves the first ambiguity;
outputting the first question and the first selectable answers for display to the first user;
resolving the first ambiguity to provide a resolved ambiguity, including:
in response to receiving an input of a first of first the selectable answers, updating the internal information to reflect that the first of the first selectable answers is correct; and
in response to receiving an input of a second of the first selectable answers, updating the internal information to reflect that the second of the selectable answers is correct; and
after resolving the first ambiguity:
receiving another request from the first user to perform another financial services task; and
performing the another financial services task using the resolved ambiguity; and
if the user is the second user:
accessing second internal information associated with the second user;
determining a second minimum set of information required to perform the financial services task, including determining that the second minimum set of information includes a second piece of information for which the second internal information has a second ambiguity, the second ambiguity being different from the first ambiguity;
selecting, based on the second internal information and the type of the financial services task, a second question to resolve the second ambiguity; and
outputting the second question for display to the second user,
wherein the updated first internal information does not have the second ambiguity; and
wherein the second internal information does not have the first ambiguity.

13. The method of claim 12, wherein the second question is different from the first question.

14. The method of claim 12, wherein the first question and the second question are identical.

15. The method of claim 12, further comprising:
determining a first minimum number of questions required to solicit the first minimum set of information; and
determining a second minimum number of questions required to solicit the second minimum set of information, the second number being different from the first number.

16. The method of claim 12,
wherein the first internal information indicates that the first user is an existing customer of a financial institution that can perform the financial services task; and
wherein the second internal information indicates that the second user is not an existing customer of the financial institution.

17. The method of claim 12, wherein the type is one of:
an opening of a new financial account;
a refinancing of an existing loan; and
an application for a new loan.

18. The method of claim 12, further comprising:
generating, for the second question and based upon the second internal information, second selectable answers corresponding to the second question, with the second selectable answers being possible correct answers that resolve the second ambiguity, with one of the second selectable answers being an actual correct answer that correctly resolves the second ambiguity, and with another of the second selectable answers being an incorrect answer that incorrectly resolves the second ambiguity, at least one of the second selectable answers being different from every one of the first selectable answers,
wherein the first question and the second question are identical; and
wherein each one of the first selectable answers is different from every one of the second selectable answers.

19. The method of claim 12,
wherein the first internal information includes existing customer profile information and existing financial account information for the first user; and
wherein the second internal information includes existing customer profile information and existing financial account information for the second user.

20. A system, comprising:
one or more processors; and
non-transitory computer-readable instructions that, when executed by the one or more processors, cause the system to:
receive a request from a user via a graphical interface to perform a financial services task;
access, from a source, internal information associated with the user, including to obtain, using a screen scraper, data associated with the user from one or more websites;
access, from another source different from the source, additional information associated with the user;
update the internal information based on the additional information, including to introduce an ambiguity to the internal information that contradicts the internal information, to provide updated internal information;
determine a minimum set of information required to perform the financial services task, the minimum set of information including a piece of information corresponding to the ambiguity;
select, based on the updated internal information and a type of the financial services task, a question to resolve the ambiguity;
generate, for the question and based upon the updated internal information, selectable answers corresponding to the question, with the selectable answers being possible correct answers that resolve the ambiguity, with one of the selectable answers being an actual correct answer that correctly resolves the ambiguity, and with another of the selectable answers being an incorrect answer that incorrectly resolves the ambiguity;
output the question and the selectable answers for display to the user via a graphical display;
resolve the ambiguity to provide a resolved ambiguity, including to:
obtain at least a portion of the minimum set of information, including to receive for the question a selection, via the graphical interface, of one of the selectable answers, including:
in response to receiving an input of a first of the selectable answers, update the internal information to reflect that the first of the selectable answers is correct; and
in response to receiving an input of a second of the selectable answers, update the internal information to reflect that the second of the selectable answers is correct; and
after the ambiguity is resolved:
perform, subsequent to the obtain, the financial services task;
receive another request from the user to perform another financial services task; and
perform the another financial services task using the resolved ambiguity.
